(19) United States
(12) Patent Application Publication
(10) Pub. No.: US 2011/0318704 A1
(43) Pub. Date: Dec. 29, 2011

(54) Endosseus implant for use in a jaw cavity and template for making the cavity

(76) Inventor: Gernot TEICHMANN, Duesseldorf (DE)

(21) Appl. No.: 13/166,838

(22) Filed: Jun. 23, 2011

(30) Foreign Application Priority Data
Jun. 24, 2010 (DE) 102010025023.6

(51) Int. Cl. A61C 8/00; A61C 19/04

(52) U.S. Cl. 433/75; 433/173

(57) ABSTRACT

An endosseous jaw implant for insertion into a cavity formed in a jaw bone has a central implant body onto which at least one anchor wing is integrally molded. The anchor wing has a wedge-shaped cross section, and at least a front edge and/or a back face or an axis of the center of gravity of the anchor wing extends secantally away from the implant body.

The invention relates to an endosseous jaw implant for insertion into a cavity formed in a jaw bone, comprising a central implant body onto which at least one anchor wing is integrally molded. The invention further relates to a template for forming in the jaw bone the cavity into which the endosseous jaw implant may be inserted and having an essentially parallelepipedal base body that may be placed with its bottom face on the jaw bone.

Implants of this type are known. They are screwed or inserted into the jaw bone, and within a period of three to six months bond to the surrounding jaw bone to form a solid support that has an extremely high load capacity and on which a dental prosthesis may then be placed. Dental implants therefore assume the function of artificial dental roots.

The shapes of implants currently in use are generally rotationally symmetrical and have an implant body that is cylindrical, i.e. of circular cross section, and that may be inserted into a cylindrical cavity. The cavity accommodates the implant, and is generally formed in the jaw bone using a rotating tool, in particular a drill. The cylindrical implant body usually has a thread on its exterior, and the implant is screwed into the cavity. Such implants are therefore also referred to as screw implants. The advantage of screw implants is that their thread anchors them directly in the bone. In addition, the thread provides a comparatively large surface, as the result of which the implant acquires particularly high stability inside the jaw bone after the jaw bone and the implant body coalesce.

A significant disadvantage of all screw implants is that the axial length and/or diameter of the implant body must be comparatively large in order to provide a sufficiently large surface with which the jaw bone may coalesce.

The object of the present invention, therefore, is to provide a jaw implant having a novel geometry that, with a comparatively small contact surface, has a very short overall height and therefore may also be used in areas where only very little bone height is available. A further object of the invention is to provide a template for guiding a sawing tool that can form the cavity for the jaw implant according to the invention in the jaw bone with a precise fit.

This object is achieved by a jaw implant having the features of claim 1 and by a template having the features of claim 13. Advantageous refinements of the jaw implant and of the template are given in the dependent claims.

According to the invention, an endosseous jaw implant for insertion into a cavity provided in a jaw bone, comprising a central implant body onto which at least one anchor wing is integrally molded, is proposed, where the anchor wing is of a wedge-shaped cross section, and at least the front edge and/or the back face and/or the axis of the center of gravity of the anchor wing extend(s) secantally away from the implant body.

The novel jaw implant geometry has the advantage that the implant no longer has to be screwed into the jaw bone. This means that it not necessary to turn the implant by one or more complete revolutions in order to be completely inserted into the jaw bone. Rather, less than one-half revolution, in particular less than one-fourth revolution, is necessary in order to insert the implant into the jaw bone.

The simplified insertion of the jaw implant is also achieved by the fact that the geometry of the cavity to be formed in the jaw bone is altered compared to the prior art, and is no longer merely a bore designed as a blind hole. Instead, the cavity is formed by a central essentially cylindrical hollow space that on at least one face is joined to a recess having a wedge-shaped cross section, and into which the anchor wing may be inserted in a positive-fit manner. When the jaw implant is inserted into such a cavity, the anchor wing slides into the wedge-shaped recess until its front edge abuts against the front end of the recess, and thus lies in the recess in a positive-fit manner. The jaw implant together with the anchor wing is rotated between 30° and 60°, depending on the embodiment. Thus, the implant may be inserted from above into the cavity opening in the jaw bone at an angle that is offset between 30° and 60° with respect to its final position. The implant then slides on the lower face of the wedge-shaped anchor wing while rotating between 30° and 60°, into the positive-fit seat of its end position. Optimal seating of the jaw implant in the jaw bone and a high retention effect are thus achieved. The jaw implant according to the invention therefore offers ease of insertion with minimal rotation.

Within the meaning of the present invention, the term “secantal” is understood to mean the progression of a straight line that twice intersects the intersection surface of a radial plane through the implant body, and that does not pass through the center point of this cross-sectional area; i.e. the secant does not coincide with the diameter of the cross-sectional area.

The profile cross section of the anchor wing is preferably the same over its secantal length. This means that the front edge, the back face, and the axis of the center of gravity of an anchor wing extend parallel to one another, so that the anchor wing extends secantally away from the implant body. The anchor wing does not extend radially, since neither the front edge nor the back face nor the axis of the center of gravity extends through the center point of the referenced cross-sectional area.

Two opposite anchor wings may be integrally molded onto the implant body. This results in more secure seating of the jaw implant in the jaw bone, since an additional retention effect is achieved due to the second anchor wing. The two anchor wings preferably have identical geometrical designs, resulting in 180° symmetry of the implant body, i.e. an axis of symmetry with respect to the center axis of the implant body.

The implant body may have a profiled seat on the gum side for engagement with a rotary tool. This allows the jaw implant to be easily inserted into the cavity. For example, the seat may be formed by a slot or a polygonal, in particular hexagonal, recess, so that a conventional screwdriver or an Allen wrench, for example, is may be used as the rotary tool. However, any other polygonal seat may be provided for engagement of a rotary tool with the implant body.

The anchor wing(s) may preferably have a maximum secantal length between 3 mm and 7 mm, in particular between 4 mm and 6 mm, preferably 5 mm. The longer the secantal length that is selected, the greater the retention effect of the wing in the jaw bone. However, an increasing secantal length also requires a larger cavity; i.e. a larger quantity of bone must be removed from the jaw bone in order to be able to insert the jaw implant. To minimize such an invasive procedure, a compromise between the retention effect and the cavity volume must therefore be found. The secantal length of an anchor wing is the maximum distance of the end face of the anchor wing from the axial plane that extends through the center axis of the implant body and parallel to the end face of the anchor wing. In the embodiment of the implant having two anchor wings, the length of the implant from the end face of one anchor wing to the end face of the other anchor wing is preferably between 8 mm and 12 mm, in particular approximately 10 mm.

The anchor wing(s) may preferably have a top face and a bottom face that define an angle of between 15° and 30°, in particular between 20° and 22°. The top and bottom faces of an anchor wing thus form an acute angle that defines the wedge shape of the wing. An anchor wing geometry is thus obtained that requires only a minimal recess in the jaw bone for the anchor wing in order to achieve a high retention effect. In addition, a high retention effect may be achieved by the fact that the surface of an anchor wing facing the gum lies in a plane tilted by an angle of between 20° and 35° with respect to the axial plane of the implant body. In the present context, an “axial plane” is understood to mean a plane that contains the center axis of the implant body. The retention effect is higher the greater the tilt of the surface with respect to the referenced axial plane. The implant may fall out of the cavity if the angle of tilt is too low, i.e. less than 20°. In addition, when the anchor wing is designed with a surface that is tipped by greater than 35°, it is very difficult or impossible to insert the anchor wing into the cavity.

The wedge-shaped cross section of an anchor wing means that upon insertion into the cavity, an anchor wing tapers in the direction of the rotational motion, and expands in the direction opposite this rotational direction. Correspondingly, such an anchor wing has a top face and a bottom face that converge at an acute angle to a front edge that is located in front in the rotational direction upon insertion of the implant.

The front face of an anchor wing is preferably rounded. This prevents the wing from tilting when it is inserted into the cavity. The insertion operation is thus simplified.

The secantal axes of the center of gravity of the opposite anchor wings are preferably oppositely offset, in a radial plane, to the same degree with respect to the diameter of an intersecting circle through the implant body. This means that the axes of the center of gravity of the opposite anchor wings do not lie on the same straight line; i.e. the anchor wings themselves are offset with respect to one another, but the axes of the center of gravity lie in the same radial plane, i.e. are at the same height relative to the axial length of the implant body. It accordingly follows that the front edge of an anchor wing does not lie in a tangent at the lateral surface of the implant body, but, rather, is set back in parallel to such a tangent.

Since the implant must be inserted into the jaw bone via rotation, the wedge-shaped recess for the anchor wing must be open facing the bridge of the jaw bone. As a result of the above-mentioned advantageous features of the jaw implant, only a minimal quantity of the jaw bone must be removed, and a substantially positive-fit seat of the anchor wing in the cavity is achieved, so that after the implant is inserted there are no hollow spaces between the implant and the jaw bone that must coalesce, which would prolong the healing period.

For forming the cavity in the jaw bone, the invention proposes a template having an essentially parallelepipedal base body that may be placed with its bottom face on the jaw bone, and an opening for a sawing tool is provided on at least one face, the opening being extended by a guide passage for guiding the sawing tool, and the guide passage extending at an angle through the base body to the bottom face thereof.

The angle at which the guide passage extends with respect to the horizontal, through the base body of the template to the bottom face thereof, may be between 30° and 70°. The guide passage is used to accommodate and slidingly guide a sawing tool, thus allowing formation of the part of the cavity in which the anchor wing of the jaw implant is to subsequently lie in a positive-fit manner. The angle of the guide passage is therefore selected so that it is adapted to the wedge shape of the cavity to be formed.

In one preferred embodiment, the guide passage is of rectangular cross section. This has the advantage that the sawing tool may be guided on four sides. Alternatively, the guide passage may have a concave design at one or more inner sides, corresponding to the specific design of the anchor wing(s).

It is also advantageous when the base body of the template is lengthened by an extension in the direction of extension of the guide passage. The base body thus acquires a larger volume in the direction of extension of the guide passage, and therefore provides larger contact surfaces for the sawing tool. This allows better guiding of the sawing tool in the guide passage, thus ensuring precise hollowing out of the cavity part necessary for the anchor wing.

A central peg for inserting the template into a bore formed in the jaw bone may be integrally molded onto the bottom face of the base body. The bore in the jaw bone is used for the subsequent accommodation of the implant body. The peg allows the template to be fixed to the jaw bone in two directions, i.e. longitudinally and transversely, with respect to the jaw bone bridge. It would then be possible only to twist the template in its inserted state with the peg in the bore. This may be prevented by fixing the template to the jaw bone, using at least one fastener. For this purpose, for example at least one bore for a pin, screw, or some other fastener may be provided in the template that is guided through the template and lies fixedly in the jaw bone.

To produce the cavity part provided for an anchor wing, the extension of the guide passage in the template must extend, at least partially, into the bore that has previously been formed in the jaw bone. However, since the peg is located in this bore in the mounted state of the template on the jaw bone, it is practical for the peg to be cut away in its partial region in the extension of the guide passage. Otherwise, when introduced into the guide passage the sawing tool would saw or abrade the peg. As a result of the cut away area, the upper inner contact surface of the guide passage merges in flush abutment or at an obtuse angle with the partial surface of the peg formed by the cut away area, depending on the sawing tool to be used.

The cut away area of the peg may form an angle between 20° and 35° with respect to the vertical. This angle corresponds to the angle by which the top face of an anchor wing is tilted relative to the vertical, i.e. the axial plane. The cut-away area therefore lies in the same plane as the inner surface of the part of the cavity provided for the anchor wing, against which the top face of an anchor wing lies in the inserted state.

The template may have a second opening for a sawing tool on the side of the template opposite from the first opening, whereby a second guide passage that extends at an angle through the base body to the bottom face thereof adjoins this second opening. This embodiment is used to produce a cavity in the jaw bone provided for accommodating a jaw implant having two opposite anchor wings. Such a template has the advantage that it does not have to be moved after the cavity part is produced for the first anchor wing, i.e. does not have to be detached from the jaw bone and remounted, in order to produce the cavity part for the second anchor wing in the jaw bone. A work step is spared in this manner.

The two guide passages may preferably extend to the middle of the width of the template. At the upper end of the bore formed in the jaw bone, this produces a cavity expansion that opens up with a circumferential angle of up to 60°, so that it is possible to vertically insert the jaw implant into the bore, or to partially insert the anchor wings into the cavity expansion. The insertion is carried out in a position that is offset by an angle between 30° and 60° with respect to the end position, whereby the inserted implant then slides downward on the lower bevel of the cavity part while being rotated, until the front edge of one anchor wing abuts against the end of the corresponding cavity part.

A rinse opening that extends into the corresponding guide passage may preferably be provided above a guide passage. Rinse water may be introduced or exhausted through this opening, so that bone particles removed by the sawing tool may be rinsed from the cavity. The rinse opening may be designed as an oblong hole, for example, which in its longitudinal direction is parallel to the direction of extension of a guide passage.

The template is preferably symmetrical with respect to its center axis. This is an axis of symmetry relative to the center axis extending through the peg.

Further features and advantages of the jaw implant according to the invention and of the template according to the invention are provided in the following detailed description of two embodiments and the accompanying figures, in which:

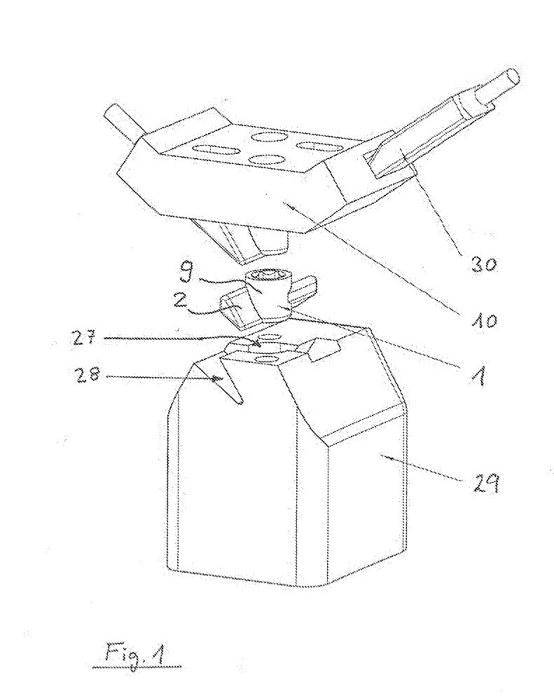

FIG. 1 is a schematic illustration of the overall system comprising the jaw bone, jaw implant, and template together with sawing tool;

FIG. 2 is a perspective view of a jaw implant according to a first embodiment;

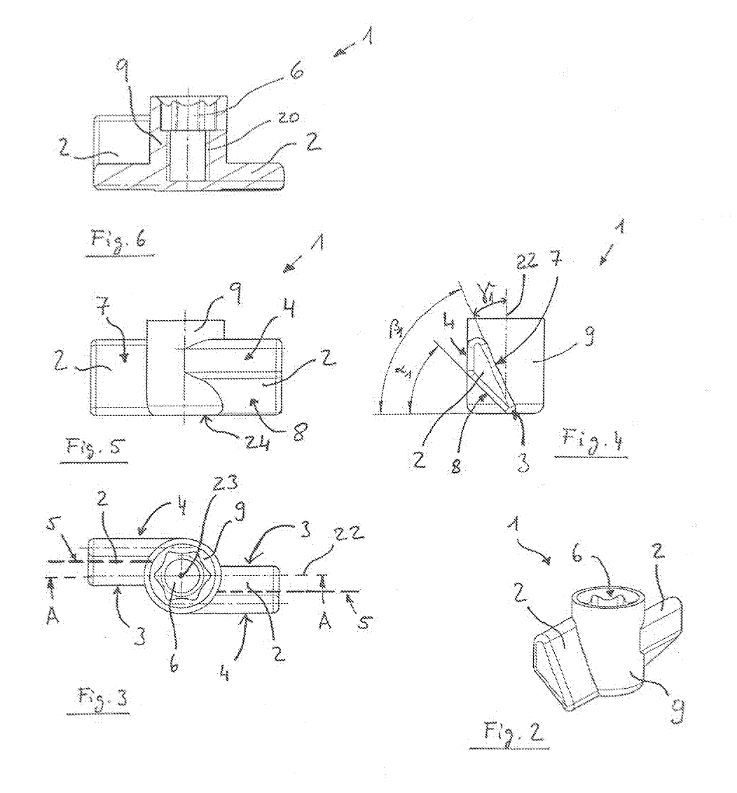

FIGS. 3, 4, and 5 are top, side, and front views of the jaw implant according to FIG. 2;

FIG. 6 is an axial section through the jaw implant according to FIG. 2 along section line A-A according to FIG. 3;

FIG. 7 shows the jaw implant according to a second embodiment;

FIGS. 8, 9, and 10 are top, side, and front views of the jaw implant according to FIG. 7;

FIG. 11 is a section of the jaw implant according to FIG. 7 along section line B-B according to FIG. 8;

FIG. 12 shows a template according to a first embodiment for forming a cavity in a jaw bone for an implant according to FIG. 2;

FIGS. 13 and 14 are top and side views of the template according to FIG. 12;

FIG. 15 is a section of the template according to FIG. 12 along section line C-C of to FIG. 13;

FIG. 16 shows the template according to a second embodiment for forming a cavity in a jaw bone for an implant according to FIG. 7;

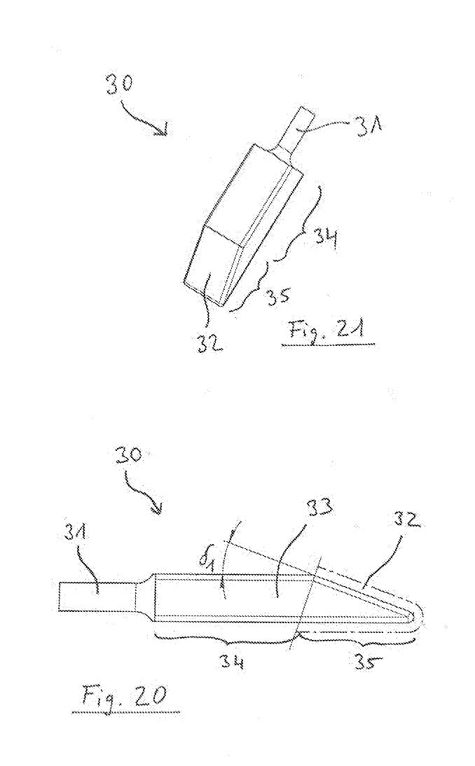

FIGS. 17 and 18 are top and side views of a template according to FIG. 16;

FIG. 19 is a section through a template according to FIG. 18 along section line D-D of to FIG. 17;

FIG. 20 is a side view of a sawing tool;

FIG. 21 is a perspective view of a sawing tool.

FIG. 1 is an overall exploded view of an exploded drawing, of the system of a jaw implant 1 according to the invention in front of a cavity 27, 28 formed in a jaw bone 29. The jaw bone 29 is shown schematically in FIG. 1, and is used for illustration. The jaw implant 1 has a central cylindrical implant body 9 and two anchor wings 2 that extend secantally away from the implant body 9 in opposite directions. The implant body 9 and the anchor wings 2 are made of one piece of metal. The cavity 27, 28 is formed by a first cavity part 27 provided for the implant body 9 and two opposite cavity parts 28 for the anchor wings 2.

FIG. 1 also illustrates a template 10 according to the invention that may be placed on the jaw bone 29. The cavity parts 28 for the anchor wings 2 of the jaw implant 1 may be formed in the jaw bone 29 when the template 10 is mounted on the jaw bone 29 using sawing tools 30 as explained in detail below.

FIG. 2 shows an endosseous jaw implant 1 in perspective view. The central implant body 9 is cylindrical. The two opposite anchor wings 2 are integrally formed with the implant body in one piece. Each of the two anchor wings 2 has a wedge-shaped cross section and extends secantally away from the implant body 9, the profile cross section of the anchor wings 2 remaining the same over their secantal length.

The implant body 9 has a profiled seat 6 on the gum side in which a rotary tool may engage. The seat 6 is a hexagonal socket so that a corresponding Allen wrench may engage with the seat 6. Torque may thus be exerted on the jaw implant 1 using a tool, in order to screw the jaw implant into the cavity 27, 28. The profiled seat 6 also accommodates an implant head, also referred to in technical terminology as an abutment. The implant head extends through the gingiva, and in turn is used for mounting a dental prosthesis.

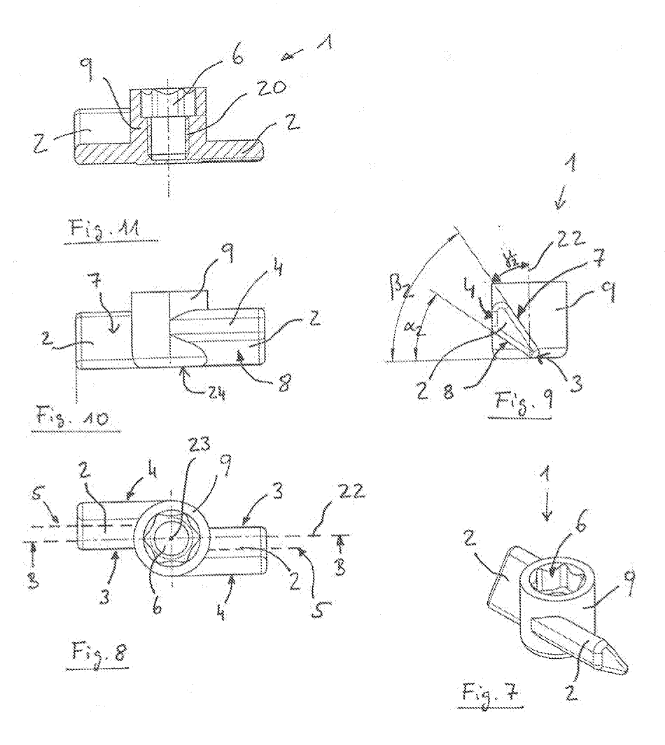

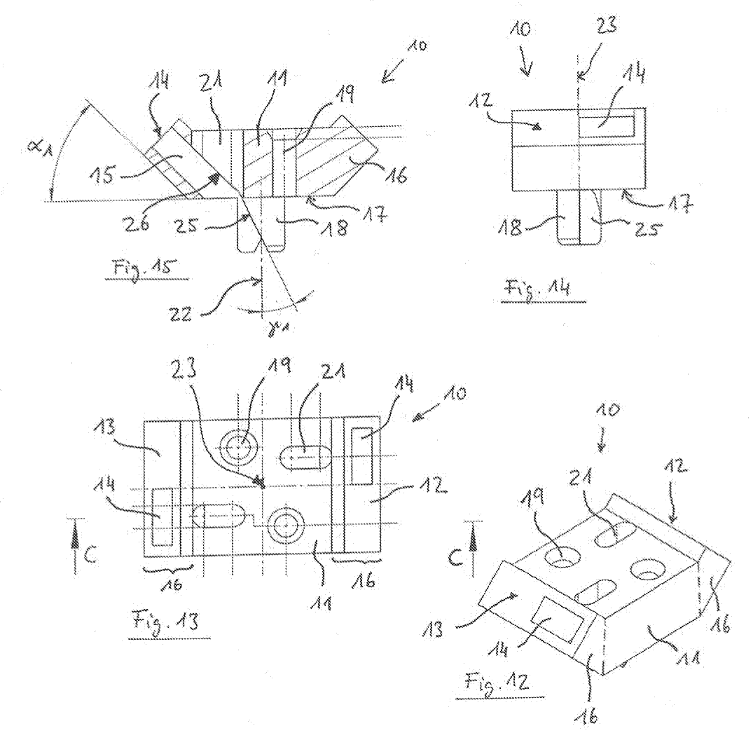

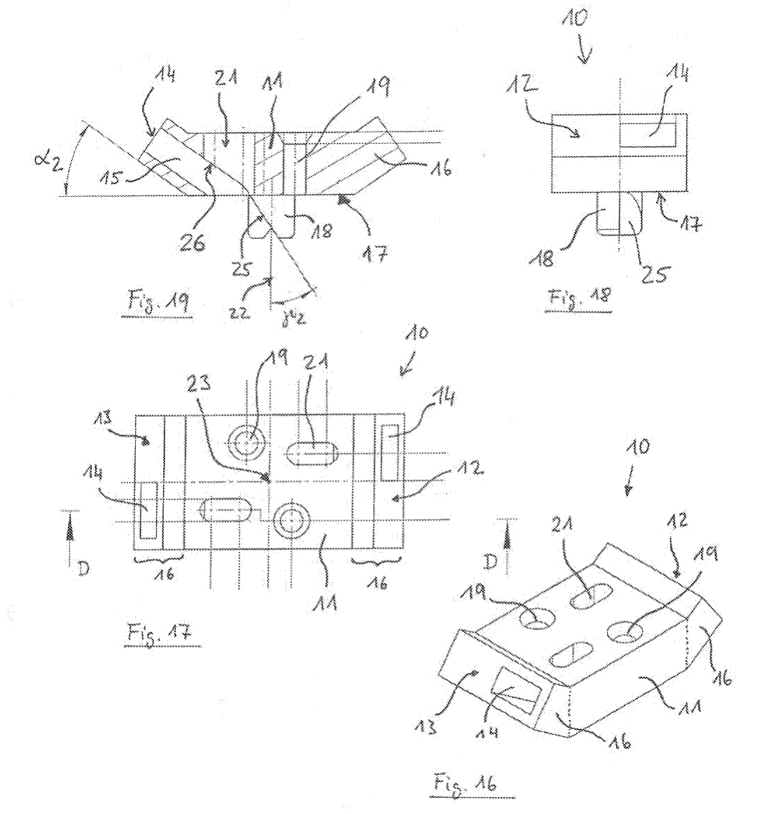

FIG. 3 shows the jaw implant 1 in a top view. A front edge 3, back face 4, and axis 5 of the center of gravity of an anchor wing 2 extend parallel to one another, in each case extending secantally from the implant body 9. The axis of the center of gravity is the axis formed by the sum of all centers of gravity of the cross sections of an anchor wing. Since the anchor wings 2 each have a wedge-shaped cross section, their cross-sectional profile is essentially triangular, so that the center of gravity of a cross-sectional area is formed by the intersection point of the median lines of the cross-sectional triangle. This is apparent from FIG. 4 that shows the profile cross section of an anchor wing 2. The corners of the cross-sectional profile are rounded.

It is apparent from FIG. 3 that the back face 4 of each anchor wing 2 lies in a plane that is tangential to the implant body 9, i.e. merges flush into the outer side surface of the implant body 9. In contrast, the front edge 3 is set back with respect to a tangential plane parallel to the back face 4 and diametrally opposite same. This means that in the standard projection in the top view, an anchor wing 2 has a width that is smaller than the diameter of the implant body 9. In addition, as shown in FIG. 3, this width is approximately 20% greater than one-half the diameter of the implant body 9. It is also apparent in FIG. 3 that the axis 5 of the center of gravity also extends secantally with respect to the implant body 9. Neither the front edge 3 nor the axis 5 of the center of gravity lies on a diameter of a radial cross-sectional circle of the implant body 9.

The secantal axes 5 of the center of gravity of the opposite anchor wings 2 are oppositely offset radially to the same degree with respect to a diametral plane through an intersecting circle of the implant body 9. It is apparent that the jaw implant 1 is symmetrical with respect to a center axis 23 and that the portion of the jaw implant 1 on the right side of this axis 23 in FIG. 3 may be converted to the portion to the left of the center axis 23 by a 180° rotation about the center axis 23.

FIG. 4 shows the jaw implant 1 in a side view of the end face of an anchor wing 2. The anchor wing has a top face 7 and a bottom face 8 that converge toward the front edge 3 at an acute angle. The edges are rounded. The front edge 3 is the portion of the anchor wing in front in the insertion direction of the jaw implant 1, i.e. during rotation.

The bottom face 8 defines an angle α₁ of 45° with respect to the horizontal. In addition, the top face 7 defines an angle β₁ of approximately 65.2° with respect to the horizontal, so that the angle between the top face 7 and the bottom face 8 is approximately 20.2°. Correspondingly, the top face 7 of the anchor wing 2 facing the gum lies in a plane tilted by an angle γ₁ of 24.8° with respect to the axial plane 22 of the implant body 9.

FIG. 5 shows a front view of the jaw implant 1 according to FIG. 2. The jaw implant has an overall width from the end face of one anchor wing 2 to the end face of the other anchor wing of approximately 10 mm. The diameter of the implant body 9 is approximately 4 mm. The height of the implant body is approximately 5 mm, and the height of the anchor wing is approximately 4 mm. This means that the axial height of the implant body 9 extends above the upper edge of an anchor wing 2 by approximately 1 mm. This has the advantage that bone material may also form above the anchor wings 2, so that after healing, the implant body 9 is completely enclosed by the jaw bone and projects sufficiently from the jaw bone 29 to accommodate an implant. The lower edge of the front face 3 merges flush into a bottom face 24 of the implant body 9.

FIG. 6 shows a cross section of the jaw implant 1 according to FIG. 2 along section line A-A from FIG. 3. FIG. 6 shows the profiled seat 6 in the implant body 9, extended on the bottom end by a bore having a thread 20, thus allowing an implant to be screwed to the implant body 9.

FIGS. 7 through 11 show a second embodiment of the endosseous jaw implant 1 according to the invention that differs from the embodiment illustrated in FIGS. 2 through 6 in that the axial height of the implant body 9 is smaller, approximately 4 mm in the second embodiment. Here as well, the implant body 9 has an axial height that projects approximately 1 mm above the upper edges of the anchor wings 2. As a result, the overall height of the anchor wings 2 in the axial direction is approximately 3 mm. In turn, it follows that the angles of the top face 7 and bottom face 8 with respect to the horizontal are changed with respect to an axial intersection plane. Thus, angle α₂ between the bottom face 8 and the horizontal is 35°, whereas angle β₂ between the top face 7 and the horizontal is approximately 56.4°. The top face 7 and the bottom face 8 of an anchor wing therefore have a flatter design compared to the first embodiment. The top face 7 and bottom face 8 define an angle of 21.4°. The top face 7 is tilted by the angle γ₂ of approximately 33.6° with respect to the axial plane 22.

In other respects, the jaw implant 1 according to the second embodiment in FIGS. 7 through 11 has the same technical features as the first jaw implant 1 according to FIGS. 2 through 6.

FIGS. 12 through 15 show a first embodiment of the template 10 according to the invention for forming at least one part 28 of a cavity 27, 28 for a jaw implant 1 according to the invention into a jaw bone 29. The template 10 has an essentially parallelepipedal base body 11 that may be placed with its bottom face 17 on the jaw bone 29. The base body 11 has extensions 16 that extend upward at an angle from the base body (see FIG. 12). An opening 14 is provided at each of the two faces 12, 13 into which a sawing tool 30 may be inserted (see FIGS. 20 and 21). A guide passage 20 forms each opening 14 and extends at an angle through the base body 11 to the bottom face 17 thereof (see FIG. 15).

The guide passages 15 are of rectangular cross section and guide the sawing tool 30 having a corresponding rectangular cross section. Rinse openings 21 formed as throughgoing slots are provided above the guide passages 15 and open into the respective guide passages 15. In addition, two bores 19 are provided in the base body 11 of the template 10, extend through the base body 11, and are used for fasteners, in particular screws. The edges of the bores 19 are beveled at their upper ends so that a countersunk head screw may be used for fastening the template 10 to the jaw bone 29.

FIG. 13 shows the template 10 in top view. The two openings 14 and also the guide passages 15 are offset with respect to one another in the direction of the width of the template 10 and extend to the middle of the width of the template 10. The template 10 is symmetrical with respect to the center axis 23. The part of the template 10 on the right side of the center axis 23 may be converted to the portion of the template 10 to the left of the center axis by a 180° rotation about the center axis 23.

FIG. 14 shows a side view of the template 10 with the face 12 visible. A peg 18 is integrally molded onto the bottom face 17 of the base body 11 so the template 10 can be fitted to a cylindrical hole 27 formed in the jaw bone 29, so that the peg 18 fixes the template in two directions of motion, namely, longitudinally and transversely, i.e. horizontally with respect to the alveolar ridge. In order to fix the template in the vertical as well as in the rotational direction about the center axis 23 of the peg 18, the template 10 may be secured to the jaw bone 29 via the bores 19 by screws.

The peg 18 is cut away in partial regions in extensions of the guide passages 15. The corresponding cut-away areas 25 each form an extension of an upper inner face 26 of a respective one of the guide passages 15 (see FIGS. 14 and 15). The area 25 and the axial plane 22 through the peg 18 define an angle γ₁ of 24.8°. This angle therefore corresponds to angle γ₁, defined by the top face 7 of an anchor wing 2 of the jaw implant 1 according to the first embodiment and the axial plane 22 through the implant body 9.

The angle by which an extension 16 or the guide passage 15 extends obliquely upward corresponds to angle α₁, defined by the bottom face 8 of an anchor wing 2 according to the first embodiment of the jaw implant 1 according to the invention, and the horizontal.

FIGS. 16 through 19 show a second embodiment of the template 10 according to the invention that corresponds to a second embodiment of the jaw implant 1. The second embodiment differs from the first embodiment solely in that its length in the direction of the guide passages 15 is greater than in the first embodiment, and that the angle α₂ by which the extensions 16 and also the guide passages 15 extend obliquely upward, is smaller. Angle α₂ is approximately 35°. As a result of this smaller angle α₂, the template 10 according to the invention is bigger longitudinally, so that the guide passages 15 are able to provide a sufficient guide surface for the sawing tools 13. In other respects, the template 10 according to the second embodiment according to the invention essentially corresponds to the first embodiment in FIGS. 12 through 15.

FIGS. 20 and 21 show a sawing tool 30 that may be used to produce the cavity parts 28. The sawing tool has a shank 31 having an essentially circular cross section and whose end region may be clamped into a piezoelectric device. The shank is attached, in particular integrally molded in one piece, to a main part 33 that has an essentially rectangular cross section in its middle region 34. The front region 35 of the sawing tool 30 has a wedge-shaped longitudinal cross section. The wedge shape is produced by flattening the main part 33 in the front region by an angle δ₁ that together with angles γ₁ forms angle α₁. The front region 35 of the sawing tool 30 completely forms the effective tool region. In this region the sawing tool 30 is diamond-coated, so that vibration of the sawing tool 30 produced by the piezoelectric device causes a filing effect by means of which bone material may be removed. FIG. 21 shows the tool 30 in perspective view.

1. An endosseous jaw implant for insertion into a cavity formed in a jaw bone, comprising a central implant body onto which at least one anchor wing is integrally molded, wherein the anchor wing has a wedge-shaped cross section, and at least a front edge and/or a back face and/or an axis of the center of gravity of the anchor wing extend secantally away from the implant body.

2. The jaw implant according to claim 1, wherein the profile cross section of the anchor wing is the same over its secantal length.

3. The jaw implant according to claim 1, wherein two opposite anchor wings are integrally molded onto the implant body.

4. The jaw implant according to claim 1, wherein the implant body has a profiled seat on the gum side for engagement with a rotary tool.

5. The jaw implant according to claim 1, wherein the anchor wing has a maximum secantal length between 3 mm and 7 mm.

6. The jaw implant according to claim 1, wherein the anchor wing has a top face and a bottom face that define an angle of between 15° and 30°.

7. The jaw implant according to claim 1, wherein the top face of an anchor wing facing the gum lies in a plane tilted by an angle of between 20° and 35° with respect to the axial plane of the implant body.

8. The jaw implant according to claim 1, wherein a front edge of an anchor wing is rounded.

9. The jaw implant according to claim 3, wherein the secantal axes err of the center of gravity of the opposite anchor wings are oppositely offset in a radial plane to the same degree with respect to a diametral plane through an intersecting circle through the implant body.

10. A template for forming in a jaw bone a cavity into which an endosseous jaw implant according to claim 1 may be inserted, having an essentially parallelepipedal base body that may be placed with its bottom face on the jaw bone, wherein an opening for a sawing tool is provided on at least one face, the opening being extended by a guide passage for guiding the sawing tool, and the guide passage extending at an angle through the base body to the bottom face thereof.

11. The template according to claim 10, wherein the guide passage is of rectangular cross section.

12. The template according to claim 10, wherein the base body is lengthened by an extension in the direction of extension of the guide passage.

13. The template according to claim 10, wherein a central peg for inserting the template into a bore formed in the jaw bone is integrally molded onto the bottom face of the template.

14. The template according to claim 13, wherein the peg is flattened in a partial region situated in the extension of the guide passage.

15. The template according to claim 14, wherein the flattened area of the peg forms an angle between 20° and 35° with respect to the vertical.

16. The template according to claim 10, wherein the template has a second opening for a sawing tool situated on the side opposite from the first opening, a second guide passage for guiding the sawing tool extending at an angle through the base body to the bottom face thereof and adjoining the second opening.

17. The template according to claim 16, wherein the two guide passages are offset with respect to one another in the direction of the width of the template, and extend to the middle of the width of the template.

18. The template according to claim 10, wherein the template has at least one bore for accommodating a fastener for fixing the template to the jaw bone.

19. The template according to claim 10, wherein the template has a rinse opening above a guide passage that extends into the corresponding guide passage.

20. The template according to claim 10, wherein the template is 180° symmetrical with respect to its center axis.
